(19) United States
(12) Patent Application Publication
(10) Pub. No.: US 2017/0071382 A1
(43) Pub. Date: Mar. 16, 2017

(54) DISPOSABLE STRAW DRINKING SYSTEM FOR USE WITH A BEVERAGE DISPENSER

(71) Applicant: Mohammad Hossein Dehghan Dehnavi, Yazd (IR)

(72) Inventor: Mohammad Hossein Dehghan Dehnavi, Yazd (IR)

(21) Appl. No.: 15/342,077

(22) Filed: Nov. 2, 2016

(30) Foreign Application Priority Data
Nov. 3, 2015 (IR) 13945014000300873

(51) Int. Cl. A47G 21/18; B67D 3/00; A47G 19/30

(52) U.S. Cl. CPC A47G 21/18; A47G 21/184; B67D 3/0032; B67D 3/0009; B67D 3/0022

(57) ABSTRACT

A disposable straw drinking system for use with a beverage dispenser is disclosed. The straw drinking system includes a straw dispenser for storing and dispensing of new straws to be used with the straw drinking system. Once retrieved from the straw dispenser, the new straw can be inserted into an opening of a beverage dispensing unit. The beverage dispensing unit is connected through a flexible tube to a beverage reservoir of the beverage dispenser to provide for easy flow of the beverage from the beverage dispenser to the straw inserted into the beverage dispensing unit. The pressure of the beverage being dispensed through the straw can be controlled by a control unit of the beverage dispensing unit. For example, applying more pressure on the control unit can result in beverage being dispensed with more pressure. Once the straw has been used once for a user, it can be inserted into a used straw unit to be discarded.

### CROSS REFERENCE TO RELATED APPLICATION

This application claims the benefit of priority to an Iran patent application having serial number 139450140003008735 filed on Nov. 3, 2015, which is incorporated by reference herein in its entirety.

### TECHNICAL FIELD

The present application relates generally to beverage dispensers, and more particularly, to a disposable straw system for use with a beverage dispenser.

### BACKGROUND

Beverage dispensers can be found in many offices, workplaces and homes. One of the most common types of beverage dispensers is a water cooler. Water coolers are provided for the supply of cold, ambient or heated water to a consumer. These water coolers generally include a housing upon which a water bottle is put upside down. The housing can be a cooler housing, and in some cases includes a mechanism for warming the water to provide heated water. Usually the cooler housing contains a cooling device, a reservoir for cold water, and two water taps, one for cold water and another for either ambient or heated water.

To consume the water provided by a water cooler, a cup, glass, or other container is generally required. The cup is placed underneath one of the water taps before the tap is either pulled or pushed to dispense the water into the cup for consumption. This means that each use of the water cooler requires a cup.

When water coolers are used at places of business frequented by numerous users, disposable cups are the only practical solution for providing sanitary water to the consumers. This generally results in use of a large number of disposable cups, each of which are used only once and discarded afterwards. This can create a large amount of waste, generally consisting of plastic or Styrofoam cups which is highly detrimental to the environment. Moreover, disposable cups generally take up a lot of space, thus requiring someone to frequently replenish the stack of new cups and remove the discarded ones. Additionally, the cups are generally an unnecessary expense for a business. Furthermore, use of water cups generally results in wasting drinking water, as a number of consumers pour more water in their cups than they are likely to drink.

Therefore, a need exists for a solution for providing water to users of a water cooler in a sanitary, economically beneficial and environmentally efficient manner.

### SUMMARY

The instant application describes a straw drinking system for use with a beverage dispenser. The straw drinking system includes a dispensing unit having a handle and a flexible tube, a support unit for holding the handle in place, and a used straw unit for discarding and storing used straws. The dispensing unit is connected through an opening of the flexible tube to a beverage reservoir of the beverage dispenser to provide for a flow of a beverage from the beverage dispenser to the handle. The handle includes an opening into which a straw can be inserted and through which the beverage can exit. The used straw unit includes a conduit having an opening through which a used straw can be inserted for disposal. In one embodiment, the conduit includes a mechanism for punching a hole into the used straw as it passes through the conduit.

The straw drinking system can be used for drinking a beverage from a beverage dispenser by obtaining a new straw, inserting a first end of the new straw into an opening of a beverage dispensing unit handle, inserting a second end of the straw into a user's mouth, pressing a control unit on the beverage dispensing unit handle to initiate dispersion of a beverage, releasing the control unit to stop dispersion of the beverage, and removing the second end of the straw from the user's mouth and inserting the second end into an opening of a used straw unit conduit to discard the straw into the used straw unit conduit. In one embodiment, as the used straw passes through the conduit, a hole is punched into the straw to prevent reusing used straws.

### BRIEF DESCRIPTION OF THE DRAWINGS

Features of the subject technology are set forth in the appended claims. However, for purpose of explanation, several implementations of the subject technology are set forth in the following figures.

FIG. 1 illustrates a schematic drawing of a conventional water cooler, according to an implementation.

FIG. 2 illustrates a schematic drawing of a water cooler implementing a disposable straw drinking system, according to an implementation.

FIGS. 3A-3B illustrate schematic drawings of a straw dispenser for use with a water cooler, according to an implementation.

FIG. 4A illustrates a schematic drawing of a water dispensing unit for use with a water cooler, according to an implementation.

FIG. 4B illustrates a schematic drawing of a used straw dispensing unit for use with a water cooler, according to an implementation.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings. As part of the description, some of this disclosure's drawings represent structures and devices in block diagram form in order to avoid obscuring the invention. In the interest of clarity, not all features of an actual implementation are described in this specification. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the invention, and multiple references to “one embodiment” or “an embodiment” should not be understood as necessarily all referring to the same embodiment.

Water coolers are commonly used at places of business such as banks, doctor's offices and other businesses frequented by numerous consumers, to provide drinking water. The most common way of drinking water from a water cooler in such businesses is to place a disposable cup underneath the water cooler tap to dispense the water into the cup for consumption. This requires placing a stack of disposable cups near the water cooler. Once these cups are used, they need to be disposed of, thus requiring the placement of a large trash can near the water cooler. For businesses that have a lot of foot traffic, this means that a person needs to continually refill the stack of new disposable cups and empty the trash can holding the discarded ones. This takes a lot of time, leading to a labor expense for the business. Additionally, the cost of the actual cups can be significant because of the number of cups used on a daily basis. For example, by some estimates, around 200 disposable cups are used for water coolers each day at a bank. This number comes to around 60,000 cups a year, which is not only costly for a business but is also highly detrimental for the environment. Furthermore, use of disposable water cups can result in wasting drinking water, as a number of consumers pour more water in their cups than they are likely to drink.

Various solutions may be considered to solve the above issues. Some of the solutions may include a disposable straw drinking for use with water coolers and other beverage dispensers. A straw takes up a lot less space than a disposable cup, thus requiring a smaller space for storage of new and used straws. A straw also uses a much smaller amount of plastic than a disposable cup and as such is a much better choice for the environment. Additionally, straws are less costly to purchase and because they take up a lot less space, they require less frequent refilling and removing of discarded ones.

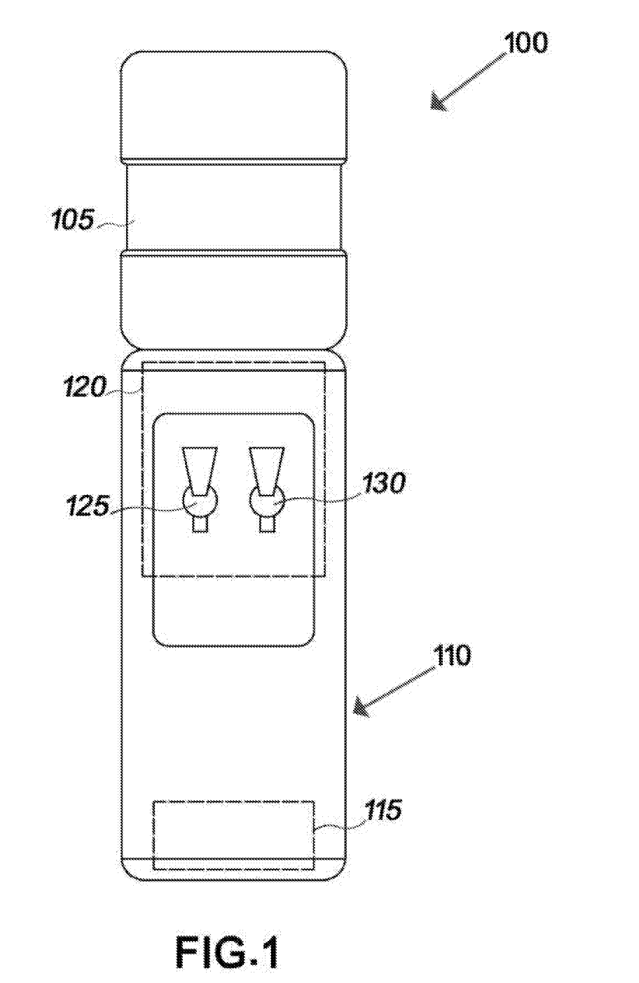

FIG. 1 illustrates a conventional water cooler 100, which is one that can be found in many offices and work places. Water cooler 100 includes a water bottle 105 and a housing 110, upon which the water bottle 105 is seated. The water bottle 105 is generally inverted before being placed on top of the housing 110. The housing 110 is generally a container that includes a cooling device 115, a reservoir 120 for storing cold water, and in some embodiments a heating device (not shown) for heating the water and a heated water reservoir (also not shown) for storing the heated water. The housing 110 can be a container that includes the cooling device 115 and the reservoir 120. When placed on top of the housing 110, water from the water bottle 105 flows by gravity from the opening of the water bottle 105 through the cooling device 115 and to the cold water reservoir 120. To use this water cooler, a cup needs to be placed underneath one of the water taps 125 and 130 for cold water and ambient or heated water, respectively. It should be noted that FIG. 1 does not indicate conduits, connectors, and valves between the different elements of the water cooler. These parts would be apparent for a person skilled in the art.

As discussed above, there are many disadvantages associated with using disposable water cups with a water cooler such as the one illustrated in FIG. 1. To overcome these issues, in one embodiment of the present invention, a disposable straw drinking system which can be installed on any water cooler is disclosed.

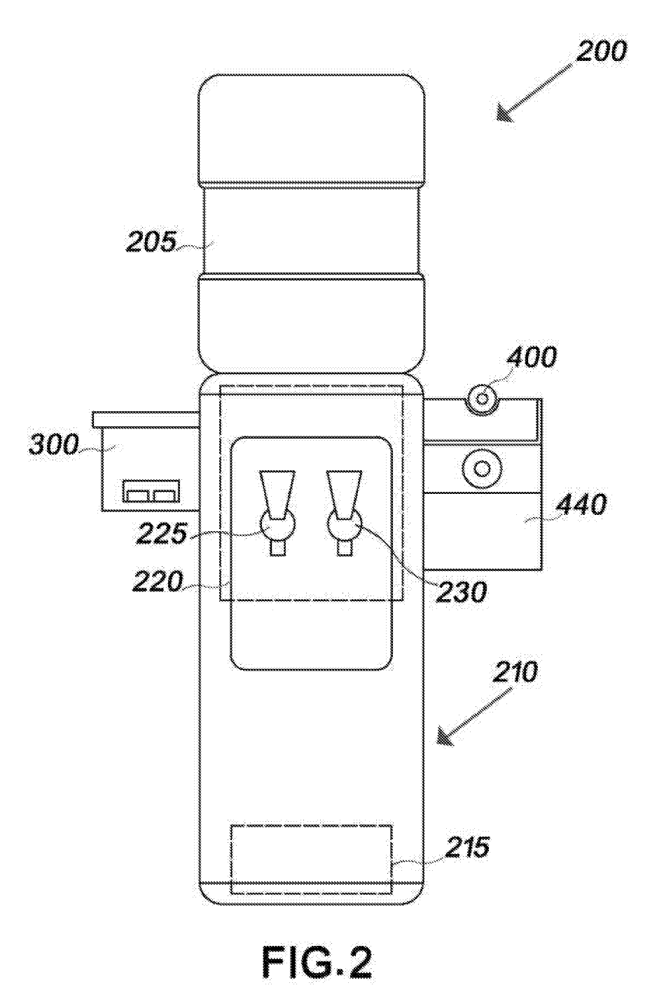

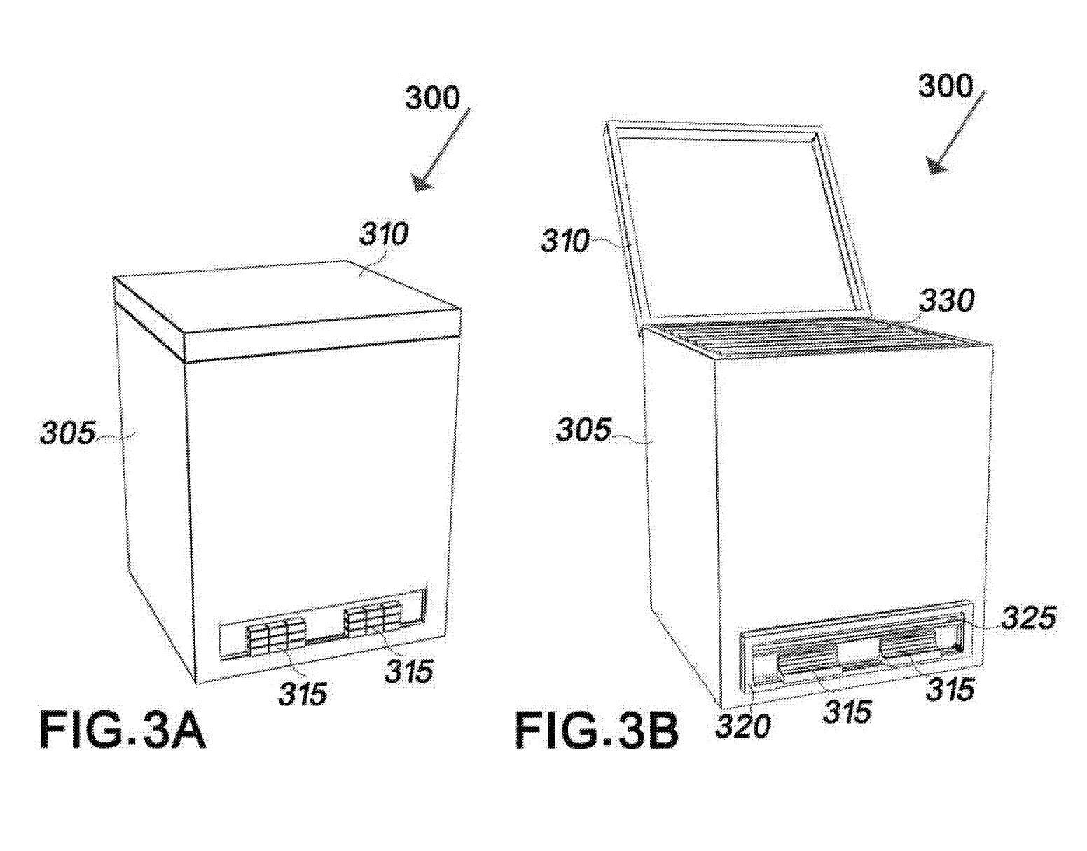

FIG. 2 illustrated a water cooler 200 which includes a disposable straw drinking system. The water cooler 200 includes bottle water 205, housing 210, cooling device 215, reservoir 220 and water taps 225 and 230, similar to the water cooler 100 of FIG. 1. Additionally, water cooler 200 includes, in one embodiment, a straw dispenser 300 for storing and dispensing of straws. The straw dispenser 300 is illustrated in more detail in FIGS. 3A-3B.

As shown, the straw dispenser 300 includes a straw housing 305 for storage of straws 330. The straw housing 305 is, in one embodiment, a rectangular shaped box designed to efficiently hold as many of, a standard size, straws as possible. Alternatively, the straw housing can be in the shape of a cup or any other shape feasible for holding straws. The straw dispenser 300 also includes a lid 310 designed to be easily lifted from the straw housing 305 for refilling of straws, as shown in FIG. 3B. In one embodiment, two protrusions 315 are located in the bottom of the straw housing 305. Once pressed down, the protrusions 315 reveal an opening 320 through which a straw 325 can slide out, enabling a user to access a straw without the need to touch any other straws. This is because, in one embodiment, only one straw can slide out at a time. Alternatively, the straw housing 305 may include a small slit through which a user can retrieve a straw. In one embodiment, the straw dispenser is configured for six inch straws. Other size straws are used in alternative embodiments.

As shown in FIG. 2, the straw dispenser 300 can be attached to the water cooler 200, thus avoiding the need for extra space for storage and display of straws. Because straws take up a lot less space than cups, it is possible to store a much larger number of straws in the straw dispenser 300 than it would have been with cups. Moreover, because the straw dispenser is a relatively small box, it is possible to easily attach it to the water cooler. The straw dispenser can be attached to the water cooler permanently, as shown in FIG. 2. Alternatively, the straw dispenser can be attached so that is removable. For example, the straw dispenser can fit into slits located on the side of the water cooler. Other methods of removably attaching the straw dispenser are known in the art. In one embodiment, the straw dispenser can be attached to a conventional water cooler by a variety of fastening methods known in the art, to retrofit the conventional water cooler for use with the disposable straw drinking system of FIG. 2.

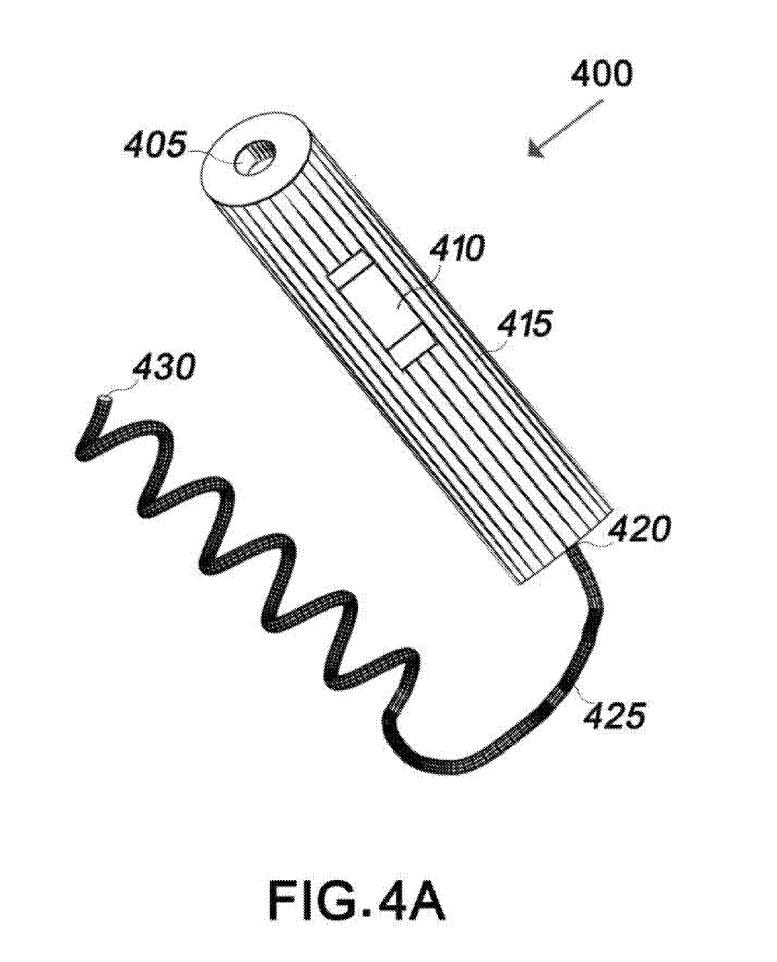

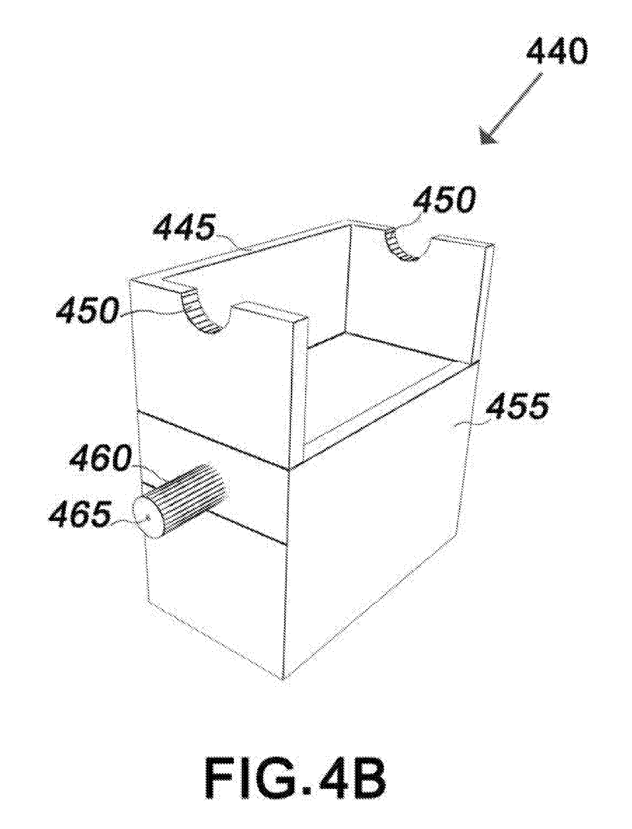

Referring back to FIG. 2, the disposable straw drinking system includes a water dispensing unit 400 which, in one embodiment, is attached to the water reservoir 220 for dispensing cold water. FIG. 4A illustrates the water dispensing unit 400 in more detail. As shown, the water dispensing unit 400 includes a handle 415 through which water can flow. A circular opening 405 located in front of the handle 415 is configured such that a straw can be inserted into it. The opening 405 is generally configured for straws having a predetermined diameter. In one embodiment, the opening 405 includes a holding mechanism (not shown) by which it securely holds a straw in place during use. Various holding mechanisms for holding a straw inside an opening are known in the art.

Water dispensing unit 400 also includes a control unit 410 for regulating the flow of water. In one embodiment, the control unit 410 controls the flow of water being dispensed from the dispensing unit 400. For example, applying more pressure on the control unit 410 results in the water being dispensed from the dispensing unit 400 having a higher pressure. Applying less pressure on the control unit 410 results in lower pressure water. In the bottom, the handle 415 is connected through an internal opening 420 to a flexible tube 425. The flexible tube 425 can be expanded when pulled. This enables a user to move around while drinking the water. It also ensures that users of different heights are able to comfortably consume the water being dispersed from the dispensing unit 400. For example, a tall user can pull the handle 415 higher thus causing the flexible tube 425 to expand and accommodate the user's height. In one embodiment, once pressure is no longer being applied to the flexible tube 425, it goes back to its original shape and/or size. In this manner, a short user such a child is also able to comfortably use the dispensing unit 400 without having to worry about the tube being in the way. The flexible tube 425 is connected through an opening 430 to one or more water reservoirs of the water cooler 200. In one embodiment, the opening 430 is permanently fastened to an opening of the water reservoir 220. In an alternative embodiment, the opening 430 is interchangeably connected to a cold water reservoir and an ambient water reservoir. In such embodiments, a switch (not shown) may be provided on the water cooler 200 to enable the user to select either cold or ambient water. In one embodiment, the opening 430 is connected to a mechanism inside the water reservoir 220 (not shown) that regulates water pressure. In one embodiment, this mechanism includes a switch for high pressure, a switch for low pressure, a three-way splitter, water pump, and an adaptor (neither of which are shown). Alternatively, in instances where water enters the water reservoir from a municipal water tap, the mechanism could include a water reservoir that receives pressure from the water tap. In one embodiment, the mechanism for regulating water pressure operates in such a manner as to ensure that water can only exit from the opening 405 and not enter it. This ensures that the use of the water that has entered a user's mouth or touched a user's lips does not enter the water dispensing unit, thus ensuring a sanitary means for consuming water.

Referring back to FIG. 2, the water cooler 200 also includes a support and used straw dispensing unit 440. The support and used straw dispensing unit 440 is illustrated in more detail in FIG. 4B. As shown, the support and used straw dispensing unit 440 includes a support unit 445 for holding the handle 415 in place. The support unit 430 includes two concaved cavities 450 that are shaped to accommodate the shape of the handle 415. The support and used straw dispensing unit 440 also includes a used straw bin 455 for collecting and storing discarded straws. The used straw bin 455 includes an inside container (not shown) that can be removed to empty the discarded straws. In one embodiment, the inside container can be pulled out like a drawer and re-inserted though slots inside the used straw bin 450. A used straw can be discarded through the opening 465 of the conduit 460. In one embodiment, the conduit includes a mechanism for punching a hole into each discarded straw to ensure that discarded straws are not reused.

In one embodiment, to drink water from the water cooler 200, the user retrieves a straw from the straw dispenser 300, before removing the handle 415 from the support unit 430. Once the handle 415 is removed, the user inserts the straw into the opening 405 of the handle 415. The user then places the straw inside their mouth before applying pressure on the control unit 410 to initiate dispersion of water. In one embodiment, the control unit 410 is located on the handle 415 such that when the user holds the handle 415 to place the straw in their mouth, the user's thumb conveniently falls on the control unit 410. The user regulates the water pressure by the amount of pressure applied to the control unit 410. Once, the user is done drinking water, they align the straw with the opening 450 and push the water dispensing unit 400 against the opening 465 to release the straw from the handle 415 and into the discarded straw bin 455, thus providing an easy efficient and sanitary manner to drink water from a water cooler.

In addition to conventional water coolers, the disposable straw drinking system discussed above can also be used for other types of beverage dispensers. For example, the disposable straw drinking system can be used with water fountains, refrigerators that provide cold drinking water, or even a regular water tap. In one embodiment, the disposable straw drinking system can be used with beverage dispensers that provide carbonated drinks. In each of these situations, the opening 430 of the flexible tube 425 may be connected, by any of the known methods in the art, to a beverage reservoir of the respective beverage dispensing device to provide the beverage through the dispensing unit 400.

Furthermore, the disposable straw drinking system discussed above can be retrofitly installed on any conventional water coolers. In one embodiment, a retrofit installation kit may be provided with the disposable straw drinking system for such installation. The installation kit may include, for example, conduits and connectors for connecting the opening 430 of the flexible tube 425 to one or more reservoirs of a conventional water kit.

In one embodiment, the straw dispenser, the support unit and the used straw bin are made from ABS plastic. Some or all of the connectors are made from bronze materials and o-rings are made from silicon. The water handle includes an antibacterial cover and all screws and nuts are made from stainless steel to provide a sanitary environment for consumption of water or other beverage.

The separation of various components in the examples described above should not be understood as requiring such separation in all examples, and it should be understood that the described components and systems can generally be integrated together in a single packaged into multiple systems.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus the following claims are hereby incorporated into the Detailed Description, with each claim standing on its own as a separately claimed subject matter.

What is claimed is:

1. A straw drinking system for use with a beverage dispenser comprising:
a dispensing unit having a handle and a flexible tube;
a support unit for holding the handle in place; and
a used straw unit for discarding and storing used straws;
wherein the dispensing unit is connected through an opening of the flexible tube to a beverage reservoir of the beverage dispenser to provide for a flow of a beverage from the beverage dispenser to the handle, the handle including an opening into which a straw can be inserted and through which the beverage can exit,
wherein the used straw unit includes a conduit having an opening through which a used straw can be inserted for disposal.

2. The straw drinking system of claim 1, wherein the handle includes a control unit for controlling the pressure of the beverage being dispensed from the opening of the handle.

3. The straw drinking system of claim 2, wherein applying more pressure on the control unit results in the beverage being dispensed from the opening of the handle having a higher pressure.

4. The straw drinking system of claim 2, wherein applying less pressure on the control unit results in the beverage being dispensed from the opening of the handle having less pressure.

5. The straw drinking system of claim 1, wherein the handle includes a holding mechanism through which the straw is held in place inside the opening of the handle.

6. The straw drinking system of claim 5, wherein pressing the dispensing unit against the opening of the conduit results in the straw being released from the holding mechanism.

7. The straw drinking system of claim 1, wherein the conduit includes a mechanism for punching a hole into each used straw as the used straw passes through the conduit.

8. The straw drinking system of claim 1, wherein the used straw unit includes a removable bin for storing used straws.

9. The straw drinking system of claim 1, further comprising a straw dispenser for storing and dispensing new straws.

10. The straw drinking system of claim 1, further comprising a mechanism for regulating water pressure to ensure water does not enter the opening of the handle.

11. A method for drinking a beverage from a beverage dispenser comprising, obtaining a new straw;
inserting a first end of the new straw into an opening of a beverage dispensing unit handle;
inserting a second end of the straw into a user's mouth;
pressing a control unit on the beverage dispensing unit handle to initiate dispersion of a beverage;
releasing the control unit to stop dispersion of the beverage; and
removing the second end of the straw from the user's mouth and inserting the second end into an opening of a used straw unit conduit to discard the straw into the used straw unit conduit.

12. The method of claim 11, wherein applying more pressure on the control unit results in the beverage being dispensed from the handle having a higher pressure.

13. The method of claim 11, wherein applying less pressure on the control unit results in the beverage being dispensed from the handle having less pressure.

14. The method of claim 11, further comprising moving the control unit in a certain direction to release the used straw into the opening of the conduit.
